(19) United States
(12) Patent Application Publication
(10) Pub. No.: US 2002/0012379 A1
(43) Pub. Date: Jan. 31, 2002

(54) Thermal analysis apparatus

(76) Inventor: Ryoichi Kinoshita, Mihama-ku (JP)

Correspondence Address: ADAMS & WILKS, 31st Floor, 50 Broadway, New York, NY, 10004, US

(21) Appl. No.: 09/848,142

(22) Filed: May 3, 2001

(30) Foreign Application Priority Data
May 8, 2000 (JP) 2000-134840

(51) Int. Cl. G01N 25/00

(52) U.S. Cl. 374/12; 374/31

(57) ABSTRACT

A differential thermal analyzer/differential scanning calorimeter has a sample holder supported by a temperature detector inside a heat sink. The sample holder has a bottom wall defining a mounting surface and a side wall. During a measurement, a sample is placed on the mounting surface in the sample holder and the sample holder is inclined so that the sample slides downwardly due to its own weight and contacts the sample holder side wall. A beam of electromagnetic radiation is then passed through the sample and through aligned radiation openings in the bottom wall of the sample holder and in the heat sink, and temperature measurements are taken by the temperature detector. Because the sample is in contact with both the side and bottom walls of the sample holder, heat escape is minimized during temperature measurements.

### BACKGROUND OF THE INVENTION

The present invention relates to new improvements in differential thermal analyzers or differential scanning calorimeters of thermal analyzers for studying change in physical characteristics of materials based on temperature or time. More specifically, the present invention relates to combining a differential thermal analyzer or a differential scanning calorimeter and a sample measuring device using electromagnetic radiation from a infrared spectrophotometer, an X-ray diffracting device, or X-ray scattering device using SOR light etc. in such a manner as to provide new improvements to the detector structure of the differential thermal analyzer or the differential scanning calorimeter.

Typically, the following information is obtained when a Differential Scanning Calorimeter (hereinafter referred to as a “DSC”) and a Fourier Transform Infrared spectrophotometer (“FT-IR”) or an X-Ray Diffractometer (“XRD”) are combined to perform simultaneous measurement.

While a structural change such as a phase transition corresponding to a temperature change of a sample mounted on a DSC can be detected as a DSC signal accompanying a change in enthalpy, a change of infrared absorption accompanying the structural change can be detected by an FT-IR, or a change in an X-ray diffraction spectrum accompanying a structural change can be detected by an XRD. As a result, it is possible to consider that structural changes corresponding to the temperature of the sample correspond to enthalpic change and to structural analysis results of the FT-IR and XRD.

Such simultaneous measurement devices combining a DSC and FT-IR or XRD of the related art are as follows. a) An FP-84 microscope DSC device manufactured by Mettler Toledo combined with a commercially available microscopic FT-IR system such as, for example, a differential thermo-microscopic infrared system in the FT/IR-8000 brochure published by JASCO Corporation. b) A device combining the FP-84 microscope DSC device by Mettler Toledo and an X-ray source of S O R light and performing DSC measurements and XRD measurements simultaneously with, for example, the device disclosed in Chung and Caffrey, Biophysical J.,63 (1992) 438. c) A device combining a dedicated DSC and X-ray source and performing DSC measurements and XRD measurements simultaneously as disclosed in Hirohisa Yoshida, Ryoichi Kinoshita and Yoshihiko Teramoto, Thermochimica acta, 264 (1995) 173.

In each of these cases, an aperture is provided in an appropriate manner at a container for a DSC containing a sample and a holder (normally, a temperature detector such as a thermocouple for detecting heat flow is located in the vicinity of the holder) for mounting the container so that infrared light and X-rays can pass through the sample. In addition, the aperture provided at the container is sealed with an appropriate window member through which infrared light or X-rays can be transmitted in order to prevent the sample from flowing out.

In the case of example a), because the microscope FT-IR is used, the line of the infrared beam is located in a vertical direction, the DSC is located horizontally, and the sample container is also located on the horizontal holder. On the other hand, in the case of examples b) and c), since the beam line of SOR light is in the horizontal direction, the holder for the DSC is located vertically, as is the sample container.

As a result, it is necessary to provide means for keeping the sample container from slipping down the holder.

If a DSC is mounted horizontally, the beam lines of infrared rays or X-rays are limited to the vertical direction. Therefore, the method for mounting the DSC horizontally can be applied to microscopic type FT-IRs as with example a). However, this cannot be applied to XRDs using a general purpose FT-IR, XRD and SOR light because the beam line is in the horizontal direction.

Meanwhile, if a DSC is mounted vertically in a manner suited to a horizontal beam line, it is necessary to provide a means for keeping the sample container from slipping down from the holder as in cases b) and c).

In b), the top surface of the cover of the container enclosing the sample is pushed directly by a heating block, and the bottom of the container is pressed against the holder mounting surface.

In c), a coil spring is inserted between the cover of the DSC and the top surface of the container so that the container is pressed to the holder mounting surface, or silicon grease is thinly applied to the bottom surface of the container so that the container can be adhered to the holder mounting surface.

However, if the container makes contact with surfaces other than the holder mounting surface, a heat flow path is created in addition to the heat flow path of the holder mounting surface. which causes the ability of the DSC to determine heat flow to deteriorate. In the case of c) where a coil spring is used to press down the container, a decline in heat flow sensitivity of approximately 5% is observed. In addition, when the container is raised to a high temperature, the spring material is deformed and spring force is lost, which means that the container can no longer be held. For this reason, the temperature range is limited.

Furthermore, with further means for the example c) where silicon grease is used to adhere the container to the holder mounting surface, the heat flow path is only limited to on the holder mounting surface and determination of the amount of heat does not deteriorate. The range of measurable temperature is, however, limited due to the characteristics of the silicon grease itself. For example, under high temperatures in excess of 300° C., the quality of the silicon grease itself is degraded, and in reality it is not possible to take measurements at temperatures in excess of these temperatures.

### SUMMARY OF THE INVENTION

In order to solve the above problems, the present invention is provided with a differential thermal analyzer or a differential scanning calorimeter, comprising a sample holder for mounting a sample or a sample container, an aperture, located substantially at the center of a sample holder mounting surface, for transmitting electromagnetic radiation, an edge, encompassing the periphery of the mounting surface, substantially vertical to the sample holder mounting surface, a temperature detector provided in the vicinity of the sample holder, a reference material holder located at a position symmetrical with the sample holder, and a temperature detector located in the vicinity of the reference material holder, wherein the sample holder mounting surface is inclined in an appropriate manner with respect to the vertical direction, in such a manner that the sample or the sample container is supported so as to not slide downward when mounted as a result of placing the edge encompassing the end of the mounted surface substantially vertical to the sample holder mounted surface, and the sample or sample holder makes contact with the sample holder mounting surface as a result of self-weight.

When a sample container is mounted on a sample holder of the above structure, the sample container is supported so as not to slide down by using the edge encompassing the sample holder and is located so as to be in contact with the holder mounting surface. If the gradient of the mounting surface from the vertical direction is taken to be θ, the sample holder is pushed with a force xsinθ of the weight of whole sample container toward the holder mounting surface, so as to maintain contact.

### BRIEF DESCRIPTION OF THE DRAWINGS

FIG. 1A is a cross-sectional view of a differential scanning calorimeter of a first embodiment of the present invention.

FIG. 1B is a cross-sectional view of a differential scanning calorimeter of a first embodiment of the present invention.

FIG. 2 is an explanatory drawing of force applied to a holder mounting surface by the self-weight of a sample container in the first embodiment of the present invention.

FIG. 3A is a cross-sectional view of a differential scanning calorimeter of a second embodiment of the present invention.

FIG. 3B is a cross-sectional view of a differential scanning calorimeter of a second embodiment of the present invention.

FIG. 4A is a cross-sectional view of a differential scanning calorimeter of a third embodiment of the present invention.

FIG. 4B is a cross-sectional view of a differential scanning calorimeter of a third embodiment of the present invention.

### DETAILED DESCRIPTION OF THE PREFERRED EMBODIMENT

[First Embodiment]

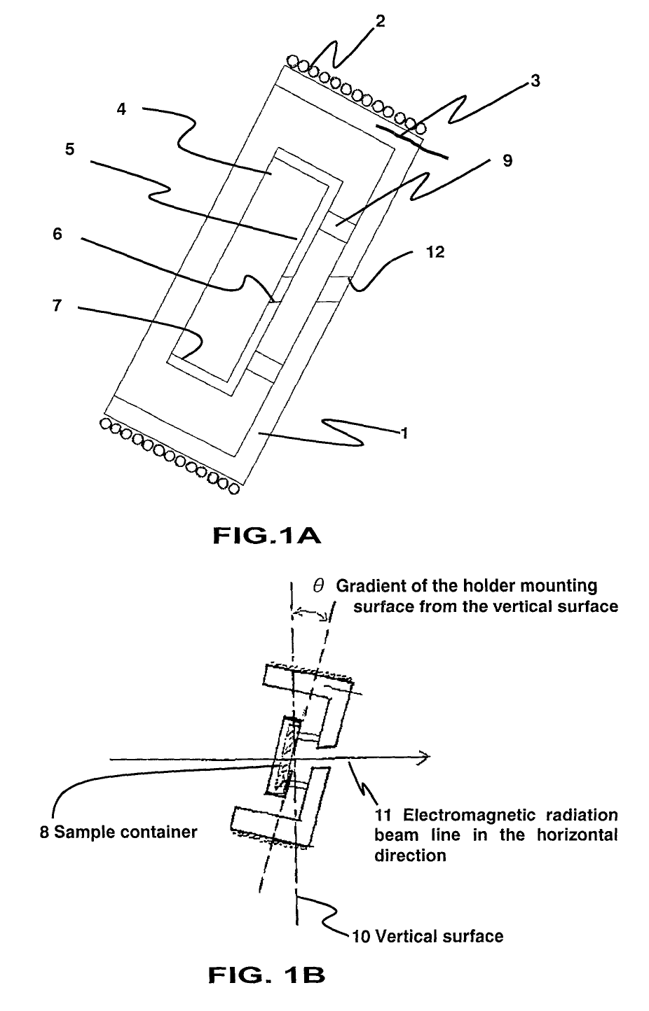

FIGS. 1A and 1B shows a cross-sectional view of a differential scanning calorimeter of a first embodiment of the present invention.

Here, numeral 1 represents a silver cylindrical heat sink with a closed bottom surface, and a heater 2 is wrapped around the outside of the heat sink, and has a controlling thermocouple 3 for controlling temperature of the heat sink 1 built-in. Temperature control is performed in an appropriate manner by a temperature programmer and a temperature control circuit (not shown).

Numeral 4 indicates a sample holder, with an electromagnetic radiation transmitting aperture 6 being provided at substantially the center part of a sample holder mounting surface 5. Numeral 7 indicates an edge of the sample holder 4. In this example, the edge is formed integrally with the sample holder mounting surface 5, so as to form a shallow dish shaped sample holder. Numeral 8 is a sample or a sample container containing the sample and is shown as being mounted on the sample holder 4. Numeral 9 is a temperature detector, with a sheath-type thermocouple being used in this embodiment. In this embodiment, four pairs of sheath-type thermocouples are brazed so as to be fixed to the heat sink 1. Further, the sample holder 4 is brazed so as to be fixed to the top ends of the sheath-type thermocouples. Although not shown, in the heat sink 1, a reference material holder is also provided at a position symmetrical with the sample holder 4, and is fixed by 4 pairs of sheath-type thermocouples as in the case of the sample holder 4. These sheath-type thermocouples forming a heat flow path from the heat sink 1 perform temperature measurement of the sample holder mounting surface. The function of a differential scanning calorimeter is fulfilled by extracting the temperature difference between the temperatures measured at the each temperature detector of the sample and the reference material and taking this temperature difference as a heat flow signal. Numeral 11 shows a beam line of electromagnetic radiation transmitted in the horizontal direction.

In this embodiment, electromagnetic radiation is incident from the left side of the drawing. After passing through the sample, the electromagnetic radiation passes through an electromagnetic radiation transmitting aperture 6 of the sample holder mounting surface, and then through an electromagnetic radiation transmitting aperture 12 provided on the bottom surface of the heat sink 1, before finally reaching to an externally located electromagnetic radiation detector.

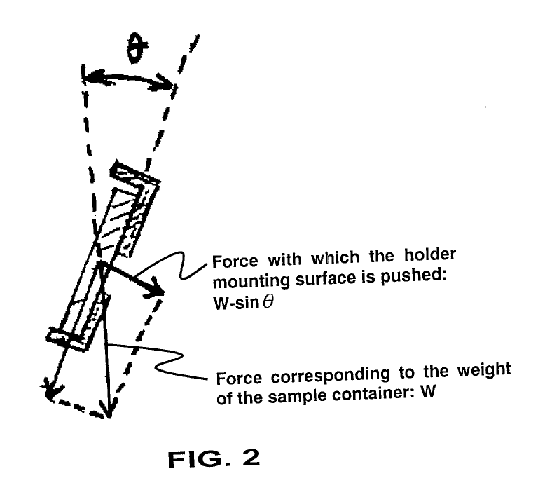

On the other hand, the sample holder mounting surface 5, together with the heat sink 1, is inclined with respect to a vertical surface 10 at an angle of θ degrees. In this way, by merely placing the sample container in the sample holder, as shown in FIG. 2, the sample container connects with the holder edge 7 and the mounting surface 5 simply due to its own weight, and an self-weight force xsinθ of the whole sample container pushes onto the mounting surface 5.

When θ is 5 degrees or more, this force is taken to be equal to or more than approximately 9% of the self-weight. Therefore, the container and the holder mounting surface can be made to make contact in an effective manner without using a coil spring to push the holder or using silicon grease etc. to adhere the holder of the related art. Although the container is also connected to the holder edge, another heat flow path is not created because the holder edge is formed integrally with a part of the holder.

Deterioration in determination of the amount of heat therefore does not occur. In addition, this method enables measurement within a range of temperatures under the same conditions as a common DSC mounted in the horizontal direction without putting upper limits on temperature due to the use of coil springs or silicon grease.

Although the open part of the heat sink at the side at which the electromagnetic radiation is incident in FIGS. 1A and 1B is not shown in the embodiment, the sample container is usually covered with an appropriate lid after mounting. However, it is also necessary to provide an aperture through which electromagnetic radiation can be transmitted.

Further, this embodiment shows mainly a heat flux-type DSC structure. However, if an appropriate temperature detector and an appropriate heater for thermal compensation are attached on the back surface of the sample holder, an input compensation type DSC for controlling feedback using the thermal compensation heater according to the temperature difference from the reference material side can bring about the same effects as the embodiment by having the holder mounting surface slightly inclined from the vertical direction.

[Second Embodiment]

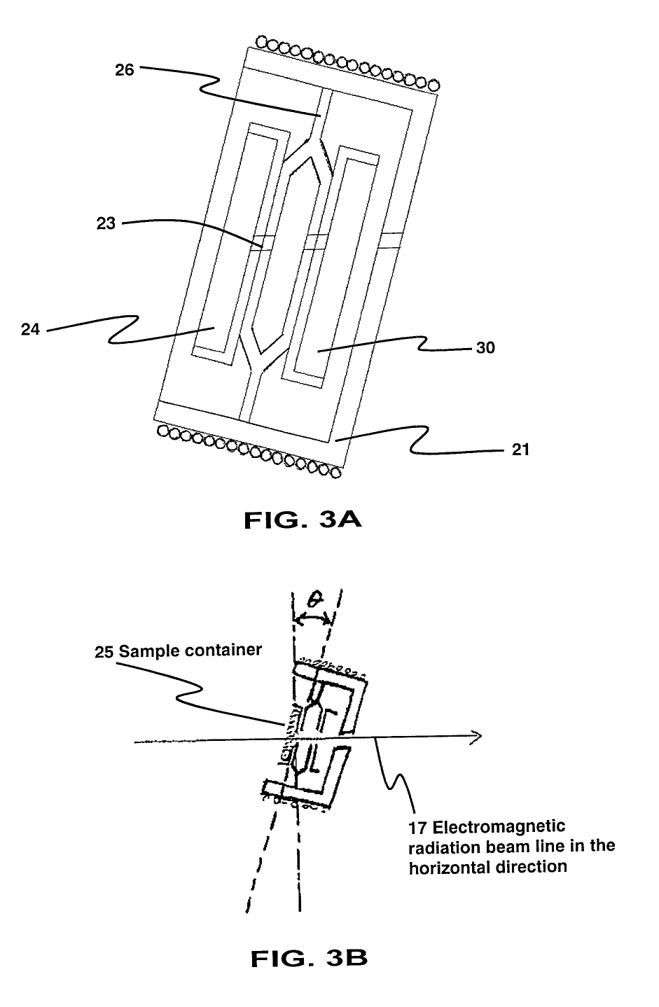

The FIGS. 3A and 3B is a cross-sectional view showing a second embodiment, describing a DSC structure disclosed in Japanese Patent Laid-open No. (1999) 166909 comprising an edge integrated around the holder on the sample side to be taken as a sample holder 24, and an electromagnetic radiation transmitting aperture 23 capable of transmitting electromagnetic radiation, having the holder mounting surface slightly inclined from the vertical direction, as in the embodiment shown in FIGS. 1A and 1B.

This embodiment is provided with an electromagnetic radiation transmitting aperture 23 substantially in the center of the holder on the reference side in order that an electromagnetic radiation can transmit using an electromagnetic beam line in the horizontal direction. Further, a heat sink 21 is also provided with an electromagnetic radiation transmitting aperture. By locating a sample container 25 at a sample holder 24, the sample container 25 makes contact with the holder mounting surface as a result of it's own weight, as shown in FIG. 2, and consequently the same effect as in the first embodiment is obtained.

[Third Embodiment]

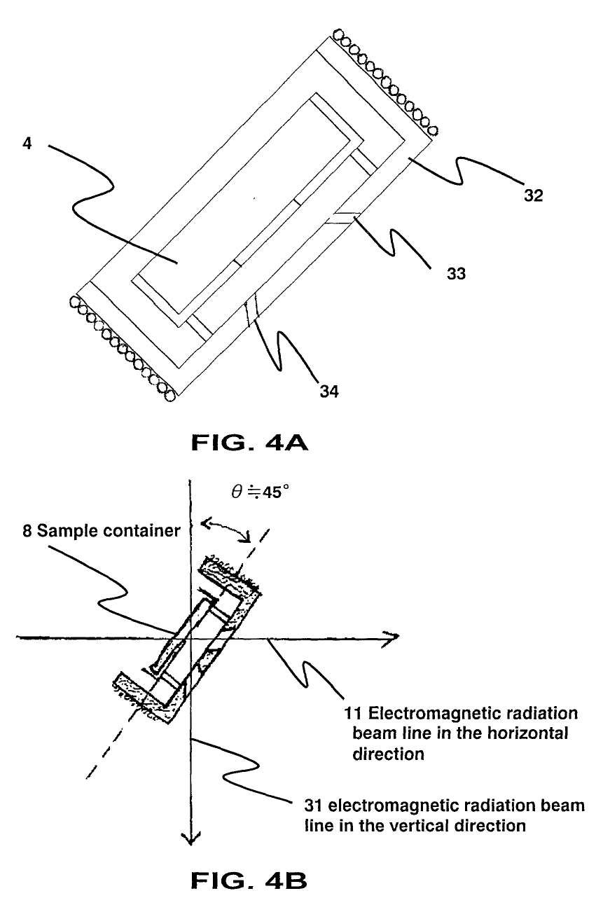

FIGS. 4A and 4B shows a third embodiment, having the holder mounting surface inclined approximately 45 degrees from the vertical direction in the DSC structure of FIG. 1. In this case, not only the horizontal electromagnetic beam line 11, but also a vertical electromagnetic beam line 31 can pass through the sample container 8 without the position being changed. A heat sink 32 is provided with electromagnetic radiation transmitting apertures 33 and 34 corresponding to each electromagnetic beam line of horizontal or vertical direction respectively so that either beam line can be radiated.

In this embodiment, as in the first embodiment, by locating the sample container 8 in the sample holder 4, the sample container is pushed to the holder mounting surface by approximately half of the force of the self-weight. In addition, because the holder mounting surface is inclined by approximately 45 degrees, it is possible for both the beam line in the horizontal direction and the beam line in the vertical direction to pass through the sample with the position of mounting remaining as is.

When a DSC of this structure is employed, combination with a device such as a microscope or microscopic FT-IR through which a beam line must be transmitted vertically can be achieved.

A holder having an edge for locating a sample or a sample container containing the sample and an aperture placed substantially at the center of a sample holder mounting surface for transmitting electromagnetic radiation are provided. Further, by having the sample holder mounting surface appropriately inclined from the vertical direction, when performing differential thermal analysis or differential scanning heat measurements while a horizontal electromagnetic beam line is transmitted through the sample, as well as preventing heat from escaping from the sample container holding structure of related arts this invention can measure up to the same level of temperature as normal measurements without performing temperature control.

In addition, by making the gradient of the sample holder mounting surface from the vertical direction approximately 45 degrees, combination with a device having either a horizontal or vertical electromagnetic beam line is possible.

What is claimed is:

1. A differential thermal analyzer, comprising:
a sample holder for mounting a sample or a sample container, an aperture, located substantially at the center of a sample holder mounting surface, for transmitting electromagnetic radiation,
an edge, encompassing the periphery of the mounting surface, substantially vertical to the sample holder mounting surface, a temperature detector provided in the vicinity of the sample holder,
a reference material holder located at a position symmetrical with the sample holder, and
a temperature detector located in the vicinity of the reference material holder,
wherein the sample holder mounting surface is inclined in an appropriate manner with respect to the vertical direction, in such a manner that the sample or the sample container is supported so as to not slide downward when mounted as a result of placing the edge encompassing the end of the mounted surface substantially vertical to the sample holder mounted surface, and the sample or sample holder makes contact with the sample holder mounting surface as a result of self-weight.

2. The differential thermal analyzer of claim 1, wherein the gradient of the sample holder mounting surface is set equal to or more than 5 degrees from the vertical direction.

3. The differential thermal analyzer of claim 1, wherein the gradient of the sample holder mounting surface is set approximately 45 degrees from the vertical direction, so as to allow transmission of electromagnetic radiation in the either horizontal or vertical directions.

4. A differential scanning calorimeter, comprising:
a sample holder for mounting a sample or a sample container, an aperture, located substantially at the center of a sample holder mounting surface, for transmitting electromagnetic radiation,
an edge, encompassing the periphery of the mounting surface, substantially vertical to the sample holder mounting surface, a temperature detector provided in the vicinity of the sample holder,
a reference material holder located at a position symmetrical with the sample holder, and
a temperature detector located in the vicinity of the reference material holder,
wherein the sample holder mounting surface is inclined in an appropriate manner with respect to the vertical direction, in such a manner that the sample or the sample container is supported so as to not slide downward when mounted as a result of placing the edge encompassing the end of the mounted surface substantially vertical to the sample holder mounted surface, and the sample or sample holder makes contact with the sample holder mounting surface as a result of self-weight.

5. The differential scanning calorimeter of claim 4, wherein the gradient of the sample holder mounting surface is set equal to or more than 5 degrees from the vertical direction.

6. The differential scanning calorimeter of claim 4, wherein the gradient of the sample holder mounting surface is set approximately 45 degrees from the vertical direction, so as to allow transmission of electromagnetic radiation in the either horizontal or vertical directions.
